(19) United States
(12) Patent Application Publication
(10) Pub. No.: US 2008/0209660 A1
(43) Pub. Date: Sep. 4, 2008

(54) Window Wiping Device

(75) Inventors: Detlef Lauk, Renchen (DE); Achim Hawighorst, Beuhlertal (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/995,903

(22) PCT Filed: Jul. 19, 2006
(86) PCT No.: PCT/EP2006/064423

§ 371 Date: Jan. 16, 2008

(30) Foreign Application Priority Data
Aug. 1, 2005 (DE) 102005036043.2

(51) Int. Cl. B60S 1/24

(52) U.S. Cl. 15/250.31

(57) ABSTRACT

The invention relates to a window wiping device, in particular for a motor vehicle, with a crank (12) mounted on an output shaft (11). In the previously known window wiping devices, the crank is screwed to the output shaft, with a certain amount of construction space being required for the screw connection. In the window wiping device according to the invention, the output shaft (11) therefore has a region (13) which protrudes over the crank (12) and can be placed onto the crank (12), thus reducing the amount of construction space required.

The invention relates to a window wiping device, in particular for a motor vehicle, comprising a crank mounted on an output shaft.

In the window wiping devices known from the prior art, the crank is screwed to the output shaft. However, a certain amount of constructional space is required for the screw connection. As, nowadays, the available constructional space is becoming increasingly confined, it also becomes more difficult to provide the required space for the window wiping device. The screw connection, moreover, necessitates a certain material and assembly cost.

The object of the invention is to improve a window wiping device of the aforementioned type, such that in future the required constructional space and the material and assembly costs are reduced.

The object of the invention is achieved by a window wiping device of the aforementioned type in which, according to the invention, the output shaft has a region protruding over the crank and which may be positioned on the crank. When the protruding region is positioned on the crank after completing the mounting operations, the constructional space of the window wiping device is markedly smaller than before, when the crank was screwed to the output shaft. After positioning the protruding region, said region now only has a fraction of the constructional space of the screw connection. Moreover, the positioning is carried out markedly more rapidly than the screwing of the crank to the output shaft. The production of screw threads on the output shaft and the nuts is able to be dispensed with in future.

The positionable region of the output shaft may be positioned particularly rapidly and cost-effectively on the crank by flanging. The flanging may, for example, be carried out by a wobble method or roller-burnishing method which may be automated, whereby a non-positive connection is produced.

If the positionable region has a bore, for positioning the protruding region on the crank, only extremely low abutment forces are required, so that the positioning is possible even when a wiper gear is mounted on the motor vehicle. Apertures in the housing of the wiper gear for receiving an abutment for the flanging process are thus not required, so that the sealing of such openings is also dispensed with.

The bore may be of conical configuration, tapering toward the bottom of the bore. As a result, the wall of the output shaft in the upper region of the bore is thinner than in the lower region of the bore, so that the abutment forces for positioning the protruding regions on the crank may be even further reduced.

The output shaft may comprise an outside cone at its end which may be fitted with the crank. As a result, when positioning the protruding region on the crank, the crank and the output shaft are pressed fixedly against one another, whereby a non-positive connection is produced. Moreover, the outside cone requires less force for flanging as the protruding region has a lower material thickness, due to the cone.

If the cone of the bore has a greater pitch than the outside cone of the output shaft, the protruding region is prevented from moving toward the inside of the bore when positioned. Instead, a defined positioning of the protruding region on the crank is ensured which, in particular, is very advantageous during automatic positioning.

A positive connection is also achieved between the crank and the output shaft, in addition to a non-positive connection, when the outside cone is provided with a knurl. When positioning the protruding region on the crank, the knurl is forced into the crank, whereby the positive connection is produced.

Expediently, the output shaft is made from steel or another material which may be flanged.

An embodiment of the window wiping device according to the invention is explained in more detail hereinafter with reference to the accompanying drawings, in which in detail:

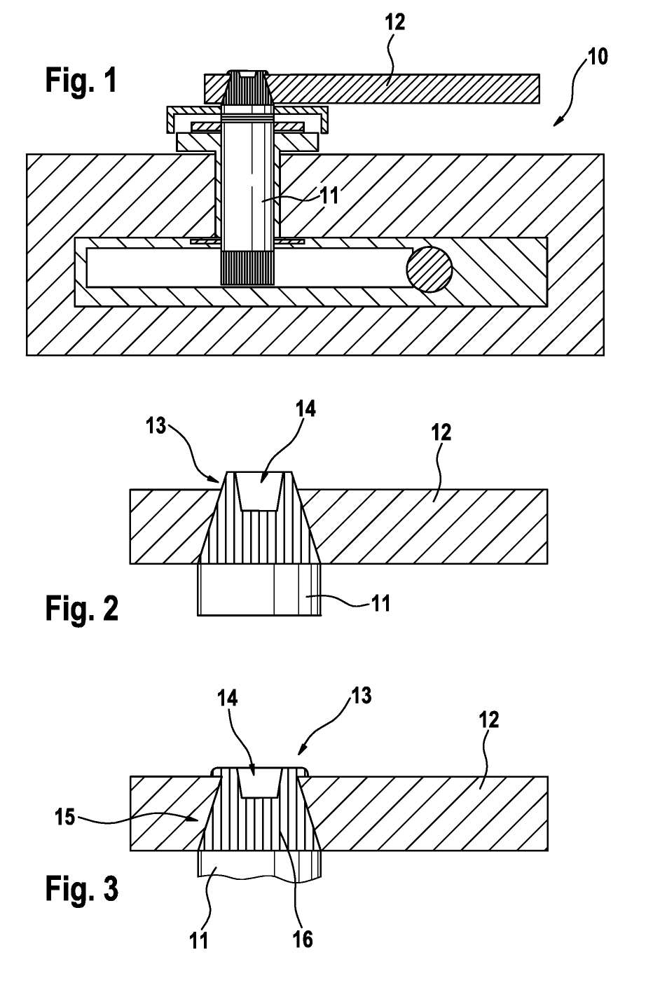

FIG. 1 shows a sectional view through the window wiping device;

FIG. 2 shows a sectional view through the output shaft and the crank before positioning the protruding region;

FIG. 3 shows a sectional view through the output shaft and the crank after positioning the protruding region.

FIG. 1 shows a window wiping device 10 comprising an output shaft 11 on which a crank 12 is mounted.

FIG. 2 shows the output shaft 11 and the crank 12 after the output shaft 11 has been inserted through an aperture in the crank 12. The output shaft 11 comprises a region 13 protruding over the crank 12.

FIG. 3 shows the protruding region 13 after said region has been positioned on the crank 12. By positioning the protruding region 13, screw connections may be dispensed with in future, whereby the constructional space required for the window wiping device 10 is reduced. As screws and nuts, as well as the production of screw threads, may be dispensed with in future, the window wiping device 10 may be produced and mounted less expensively.

The positioning of the protruding region 13 may be carried out by flanging, such as for example by a wobble method or roller-burnishing method.

The output shaft 11 is provided with a bore 14, the bore 14 being of conical design. As a result of the bore 14, in particular due to its conical design, only very low abutment forces are required for positioning the protruding region 13 on the crank 12, so that positioning is possible even when a wiper gear is mounted on a motor vehicle. Moreover, the bore serves to center a tool which is required for flanging the protruding region.

The output shaft 11 has in its upper region an outside cone 15 (see FIG. 3). As a result of the outside cone 15, the crank 12 and the output shaft 11 are pressed fixedly against one another when positioning the protruding region 13.

If the inside cone of the bore 14 has a greater pitch than the outside cone 15 (see FIG. 3), then it is ensured that the protruding region 13 is positioned outwardly on the crank 12 during the flanging.

The outside cone 15 is provided with a knurl 16, which is forced into the crank 12 when positioning the region 13, whereby a positive connection is produced.

1. A window wiping device (10), in particular for a motor vehicle, comprising a crank (12) mounted on an output shaft (11), characterized in that the output shaft (11) has a region (13) protruding over the crank (12) and which may be positioned on the crank (12).

2. The window wiping device (10) as claimed in claim 1, characterized in that the positionable region (13) may be flanged.

3. The window wiping device (10) as claimed in claim 1, characterized in that the positionable region (13) has a bore (14).

4. The window wiping device (10) as claimed in claim 3, characterized in that the bore (14) is conical, tapering toward the bottom of the bore.

5. The window wiping device (10) as claimed in claim 1, characterized in that the output shaft (11) comprises an outside cone (15) at its end which may be fitted with the crank (12).

6. The window wiping device (10) as claimed in claim 4, characterized in that the cone of the bore (14) has a greater pitch than the outside cone (15) of the output shaft (11).

7. The window wiping device (10) as claimed in claim 5, characterized in that the outside cone (15) is provided with a knurl (16).

8. The window wiping device (10) as claimed in claim 1, characterized in that the output shaft (11) is made from steel or another material which may be flanged.

9. The window wiping device (10) as claimed in claim 2, characterized in that the positionable region (13) has a bore (14).

10. The window wiping device (10) as claimed in claim 9, characterized in that the bore (14) is conical, tapering toward the bottom of the bore.

11. The window wiping device (10) as claimed in claim 10, characterized in that the output shaft (11) comprises an outside cone (15) at its end which may be fitted with the crank (12).

12. The window wiping device (10) as claimed in claim 11, characterized in that the cone of the bore (14) has a greater pitch than the outside cone (15) of the output shaft (11).

13. The window wiping device (10) as claimed in claim 6, characterized in that the outside cone (15) is provided with a knurl (16).

14. The window wiping device (10) as claimed in claim 13, characterized in that the output shaft (11) is made from steel or another material which may be flanged.

15. The window wiping device (10) as claimed in claim 5, characterized in that the cone of the bore (14) has a greater pitch than the outside cone (15) of the output shaft (11).

16. The window wiping device (10) as claimed in claim 6, characterized in that the outside cone (15) is provided with a knurl (16).
